(19) United States
(12) Patent Application Publication
(10) Pub. No.: US 2009/0022966 A1
(43) Pub. Date: Jan. 22, 2009

(54) CONTROL ELEMENT

(76) Inventors: Matthias Lust, Bad Neustadt (DE); Horst Wilhelm, Kierspe (DE); Michael Haller, Bad Kissingen (DE); Martin Stahl, Steinach (DE)

Correspondence Address: Muncy, Geissler, Olds & Lowe, PLLC, P.O. BOX 1364, FAIRFAX, VA, 22038-1364, US

(21) Appl. No.: 12/185,792

(22) Filed: Aug. 4, 2008

Related U.S. Application Data
(63) Continuation of application No. PCT/EP2007/000481, filed on Jan. 20, 2007.

(30) Foreign Application Priority Data
Feb. 4, 2006 (DE) DE 102006005089.4

(51) Int. Cl. B32B 3/10; B32B 5/16

(52) U.S. Cl. 428/206

(57) ABSTRACT

A control element is provided, in particular for a motor vehicle, including a material through which light can be passed and whish is provided with at least one opaque coating provided with symbols, and having a transparent enamel layer on the coating, wherein nanoparticles are introduced into the enamel layer and the coating and the enamel layer are removed by means of a laser.

This nonprovisional application is a continuation of International Application No. PCT/EP2007/000481, which was filed on Jan. 20, 2007, and which claims priority to German Patent Application No. DE 10 2006 005 089.4, which was filed in Germany on Feb. 4, 2006, and which are both herein incorporated by reference.

### BACKGROUND OF THE INVENTION

1. Field of the Invention

The invention relates to a control element, in particular a control element for a motor vehicle, made of a material through which light can pass, which is provided with at least one opaque coating and with a layer of transparent paint on the coating.

2. Description of the Background Art

An area of application of an embodiment of the invention is the field of motor vehicles, and there in control elements, the majority of which are backlit. Furthermore, it is also possible to use the invention in entertainment electronics, in kitchen equipment, and in washing machines, known as white goods, namely wherever control elements are used which are backlit and should have a metallic appearance in visual terms. Translucent plastics are preferably used for backlighting here, which provide the option of illuminating the control element or the pushbutton from a back side by an illuminating means and backlighting a symbol placed in the coating of the control element or pushbutton. A material used by preference for this purpose is polycarbonate (PC) or polymethylmethacrylate (PMMA); these plastics offer favorable properties with respect to processing and transillumination or backlighting.

A trend that is gaining in popularity for control elements in motor vehicles is to provide the control elements or pushbuttons with a metallic appearance. In this context, the components are injection molded from a plastic and are provided with a metallic coating by a wide variety of methods. According to the conventional art, metallic coatings providing a high gloss chrome look or the appearance of aluminum (AL) or ruthenium (RU) or a comparable shiny surface are generally applied by a galvanizing or PVD (physical vapor deposition) process.

In galvanizing, metallization is customarily accomplished using the process steps: palladium seeding, reduction, chemical metallization, for example by means of nickel or copper, and galvanic reinforcement, for example with chrome. In the PVD process, metallization is accomplished by means of physical deposition from the gas phase, for example by means of vapor deposition.

One use of a PVD process with respect to plastics for producing metallic coatings on workpieces is described in DE 103 37 456 A1. This method offers the possibility of direct metallization of the surface of the material or of a component, wherein the metallic coating consists of one or more successive layers of the same or different metals. Even materials or components with lower surface energies can be coated using the technique described in this process. The surface energies of the materials or components are activated by means of a plasma, causing very good adhesion to polymers. During plasma activation, a gas or mixture of gases is subjected to electric gas discharge in a vacuum. In this process, electrons, ions, radicals and neutral particles are generated and strike the surface of the material of the component, by which means contaminants can be removed and the surface can be roughened and chemically modified. This is followed by direct metallization, in which a chromium and aluminum layer having a total layer thickness of approximately 330 nm is produced in one example embodiment described.

The class-defining, unpublished DE 10 2005 006 459, which corresponds to US Publication No. 2008063836, and which is incorporated herein by reference describes a metallized plastic component and a method for producing a metallized plastic component with a metallic coating and a paint layer, which can be present in uncolored form, applied on the metallic coating. Described is a control element provided with a metallic coating that is applied, for example, by means of a PVD method. After the application of the metallic coating, a symbol is incorporated in the control element by means of a laser. A metal layer is subsequently deposited on this first metallic coating, for example by means of a galvanic method, so that a metallic coating having two layers is produced, in which the previously laser-cleared area is not provided with the metallic coating. If the control element is then backlit, the light emerges only from the laser-cleared area of the control element. The opaque area, in which the metallic coating is present, appears here as a metal part into which a symbol is incorporated. Also described is the application of an uncolored paint layer, which is also called a transparent lacquer layer.

### SUMMARY OF THE INVENTION

It is therefore an object of the invention to provide a control element that is provided with at least one opaque coating and that also has a transparent paint layer, wherein any desired symbol can be incorporated into the paint layer and the coating. Moreover, it should be possible to incorporate the symbol in a single work step.

A transparent paint layer can be provided with nanoparticles and the coating and the paint layer can be removed in certain areas by means of a laser. As a result of the inventive composition of the transparent paint layer, which can also be called a transparent lacquer layer, and the integrated nanoparticles, the invention now makes it possible for the transparent lacquer to be removable by means of the energy of laser irradiation. Due to the selection of the particles in the nanometer region, the transparent lacquer layer remains transparent while being activatable by means of laser irradiation. It is thus possible to manufacture the control element or control knob with an opaque coating and a transparent lacquer layer applied thereon, and to subsequently incorporate a symbol into the control element or control knob in one work step. A further advantage relative to the conventional art is that the symbol is incorporated into the control element as the last work step. Contamination of the control element by the incorporation of the symbol in an intermediate production step in the coating or during transport of the control element before painting thus cannot adversely affect the control element, i.e. the end product, or the overall production process.

As a result of the deliberate selection of the diameter of the nanoparticles incorporated into the transparent lacquer layer, the transparent lacquer layer remains transparent, so that the metallic appearance of the control element is retained. In this regard, the nanoparticles have diameters in the range from 10 nm to approximately 10 μm, and thus are not visible in the transparent lacquer layer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE shows a cross-section through a control element for, for example, a motor vehicle, representing a pushbutton for an air conditioner control unit, for example.

### DETAILED DESCRIPTION

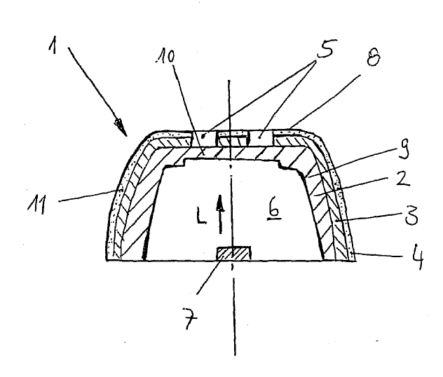

FIG. 1 shows a section through an embodied control element 1 designed in the form of a pushbutton 1. The pushbutton 1 can be hollow inside and has differing thicknesses. An opaque coating 3 is applied on the pushbutton body 2, and in turn has a transparent lacquer layer 4 applied on it. A symbol 5 has been incorporated into the coating 3 and the transparent lacquer layer 4 by means of a laser. Here, the incorporation of the symbol 5 by means of a laser is recognizable from the finely detailed and arbitrary shape of the symbol and from the removal of the coating 3 and the transparent lacquer layer, wherein the removal takes place in one work step and thus identically, which is to say in a matching manner, through both layers 3, 4. An illuminating means 7, which emits light L at least in the direction of the top 8 of the pushbutton 1, is arranged in the interior 6.

The pushbutton body 2 is limited in terms of its chemical and physical properties only to the extent that, at least in certain areas, it has a translucent material selected from the group including: glass, ceramic, or polymers. The material can be made of a polymer. Preferred polymers are plastics, such as polycarbonate (PC), acrylonitrile-butadiene-styrene (ABS), (PC+ABS) blends, polyamide (PA) or polymethylmethacrylate (PMMA). Also usable are transparent ceramics, as for example a sapphire, or glass. Depending on the required light intensity of the symbol 5, it is possible in this regard to make the material of the pushbutton body 2 with different thicknesses 9, 10. As shown in FIG. 1, the thicknesses in the areas 9 and 10 are different in order to provide adequate luminous intensity in the area of the symbol 5.

An opaque coating 3 consisting of one or more different materials can be produced on the pushbutton body 2. Thus, it is possible according to the invention to deposit a metal layer or a system of metal layers on the pushbutton body 2 by means of a PVD or CVD method. The coating 3 here had a thickness of up to 5 μm and consists of transition metals, noble metals, alloys, or metal oxide, metal carbide, or metal nitride layers, applied in one or more layers. The thickness of the coating 3 depends on the material used, and should be chosen in each case such that it is removable by laser activation. Moreover, the coating 3 can also be made from a pigmented paint. It is further possible to subject the pushbutton body 2 to a suitable pretreatment, as for example a plasma treatment. Furthermore, it is also possible to apply a primer paint to the pushbutton body 2 as the coating 3. The coating 3 should in every case be opaque, and has the advantageous property that the pushbutton body is provided with a coating 3 that is metallic or improves its appearance.

The transparent lacquer layer 4 is applied on this coating 3. The application of the transparent lacquer layer 4 takes place by, for example, spraying. Incorporated into the transparent lacquer layer 4 are nanoparticles that can be activated by the energy of a laser beam, so that the transparent lacquer layer 4 can be removed by the laser. The nanoparticles include metal oxides, as for example zinc oxide, indium tin oxide (ITO), and are transparent. The nanoparticles have a diameter between 10 nm and 10 μm. The nanoparticles are used at a volume concentration of 0.01% to 10%. The nanoparticles 11 are uniformly distributed in the transparent lacquer layer 4 and are represented as dots 11 in the transparent lacquer layer 4 in FIG. 1.

After the application of the coating 3 and the transparent lacquer layer 4, a symbol 5 is incorporated in the layer system 3, 4 having the coating 3 and the transparent lacquer layer 4 by means of a laser. This is made possible in that the transparent lacquer layer 4 can be activated by the laser, and because the coating 3 has a thickness that can be removed by the energy of the laser. Thus, it is possible according to the invention to incorporate any desired symbol 5 into the control element 1 following the coating and spraying of the pushbutton 1, and in a single operation or process step. Thus, it is possible in accordance with the invention to produce a control element 1 that has a metallic appearance and into which is incorporated a symbol that can be backlit.

Such control elements 1 can be used in motor vehicles as control elements, in commodity goods for entertainment electronics, in kitchen appliances, and in what are known as white goods, such as a washing machine with a stainless steel look.

The transparent lacquer layer 4 can have a thickness of up to 100 μm. The symbol can thus be backlit when a suitable material, which is to say substrate, is chosen, for example when polycarbonate is used as the translucent material.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control element comprising:
a translucent material that is provided with at least one opaque coating;
a symbol and a transparent lacquer layer being provided on the opaque coating; and
nanoparticles incorporated into the lacquer layer,
wherein the coating and the lacquer layer are removed in certain areas by a laser.

2. The control element according to claim 1, wherein the nanoparticles have a diameter from 10 nm to 10 μm and are present at a volume concentration of 0.01% to 10% and include metal oxides.

3. The control element according to claim 1, wherein the transparent lacquer layer has a thickness of less than 100 μm.

4. The control element according to claim 1, wherein the translucent material is a translucent plastic, a polycarbonate, a polymethylmethacrylate (PMMA), a transparent ceramic, a sapphire, or a glass.

5. The control element according to claim 1, wherein the opaque coating is a metal layer or a pigmented paint layer that is processed a laser.

6. The control element according to claim 6, wherein the metal layer has a thickness of <5 μm and is applied in one or more layers by a PVD or CVD method.

7. The control element according to claim 6, wherein the metal layer is produced by a reactive PVD method and is present as a metal oxide, metal carbide, or metal nitride layer.

8. The control element according to claim 1, wherein the translucent material is provided with an additional adhesion layer, in particular a primer paint, under the coating.

9. The control element according to claim 1, wherein the control element is a control element for a motor vehicle.
